(19) United States
(12) Patent Application Publication
(10) Pub. No.: US 2026/0075175 A1
(43) Pub. Date: Mar. 12, 2026

(54) SYSTEM, METHOD AND NON-TRANSITORY COMPUTER READABLE STORAGE MEDIUM FOR CORRECTING COLOR TEMPERATURE

(71) Applicant: Coretronic Corporation, Hsin-Chu (TW)

(72) Inventors: Chun-Hsien Wu, Hsin-Chu (TW); Ssu-Ming Chen, Hsin-Chu (TW); Chih-Hao Wu, Hsin-Chu (TW); Jung-Chi Chen, Hsin-Chu (TW)

(73) Assignee: Coretronic Corporation, Hsin-Chu (TW)

(21) Appl. No.: 19/308,308

(22) Filed: Aug. 24, 2025

(30) Foreign Application Priority Data
Sep. 10, 2024 (CN) 202411263214.8

(51) Int. Cl. H04N 9/31; G06T 7/80; H04N 9/73

(52) U.S. Cl. CPC H04N 9/3194; G06T 7/80; H04N 9/73; G06T 2207/10024; G06T 2207/20081

(57) ABSTRACT

The disclosure provides a color temperature correction system, a color temperature correction method, and a non-transitory computer-readable storage medium. The system includes a projector and an electronic device. In response to a color temperature correction instruction, the image capturing module on the electronic device is enabled, and the projector projects a light beam to form a calibration image on a projection surface. The image capturing module captures an image of the projection surface and generates an environment image. The processor acquires a region image corresponding to the calibration image within the environment image. Based on the region image and multiple capture parameters of the image capturing module at the time of capturing the environment image, the processor calculates a color temperature estimate value and sends it to the projector, which adjusts projection parameters accordingly.

### CROSS-REFERENCE TO RELATED APPLICATION

This application claims the priority benefit of China application serial no. 202411263214.8, filed on Sep. 10, 2024. The entirety of the above-mentioned patent application is hereby incorporated by reference herein and made a part of this specification.

### BACKGROUND

### Technical Field

This disclosure relates to a color temperature calibration system, a color temperature calibration method, and a non-transitory computer readable storage media, which may utilize electronic devices to assist projectors in performing color temperature calibration.

### Description of Related Art

Traditional projectors typically only provide basic display options, such as adjusting parameters like brightness, contrast, and color saturation through an On-Screen Display (OSD) menu. However, these adjustments often rely on the user's subjective judgment and do not take into account the impact of ambient light sources on the projected image quality. Especially in different environmental color temperature conditions, projectors may not be able to provide optimal display effects, as most projectors lack built-in sensors to automatically detect and adjust the color temperature of the projected image. Users need to rely on their naked eyes to judge the color temperature of ambient light, which is not only susceptible to environmental influences and personal preferences but may also lead to inaccurate adjustments.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

An embodiment of this disclosure proposes a color temperature calibration system, including a projector and an electronic device which are communicatively connected to each other. The electronic device includes a processor and an image capturing module which are communicatively connected to each other. In response to the electronic device generating a color temperature calibration instruction according to an operation, the processor enables the image capturing module and transmits a projection instruction corresponding to a calibration image to the projector. The projector projects a calibration image light beam according to the projection instruction to form the calibration image on a projection surface. The image capturing module is configured to capture an image towards the projection surface and generate an environment image. The processor obtains a region image in the environment image according to the environment image, where the region image corresponds to at least a portion of the calibration image. According to the region image in the environment image and multiple capture parameters of the image capturing module when capturing the environment image, the processor calculates a color temperature estimate value and transmits the color temperature estimate value to the projector. The projector adjusts the projection parameters of the projector according to the color temperature estimate value.

An embodiment of this disclosure further proposes a color temperature calibration method, including: in response to generating a color temperature calibration instruction according to an operation, enabling an image capturing module, and transmitting a projection instruction corresponding to a calibration image to a projector, causing the projector to project a calibration image light beam according to the projection instruction to form the calibration image on the projection surface; obtaining a region image in the environment image according to the environment image, where the environment image is generated by the image capturing module capturing an image towards the projection surface, and the region image corresponds to at least a portion of the calibration image; and calculating a color temperature estimate value according to the region image in the environment image and multiple capture parameters of the image capturing module when capturing the environment image, and transmitting the color temperature estimate value to the projector, to cause the projector to adjust the projection parameters of the projector according to the color temperature estimate value.

An embodiment of this disclosure further proposes a non-transitory computer-readable storage media, storing an application program executable by a processor. When the application program is executed by the processor, it is configured to perform the aforementioned color temperature calibration method.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

FIG. 1 is a schematic diagram illustrating a color temperature calibration system according to an embodiment.

FIG. 2 is an operational flow chart of the color temperature calibration system according to an embodiment.

FIG. 3 is a schematic diagram illustrating the capturing of a calibration image according to an embodiment.

FIG. 4 is a schematic diagram illustrating experimental results according to an embodiment.

FIG. 5 is a flow chart of a color temperature calibration method according to an embodiment.

### DESCRIPTION OF THE EMBODIMENTS

It is to be understood that other embodiment may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

This disclosure proposes a color temperature calibration system, a color temperature calibration method, and a non-transitory computer-readable storage media, which may detect color temperature through electronic devices and automatically adjust projection parameters of a projector.

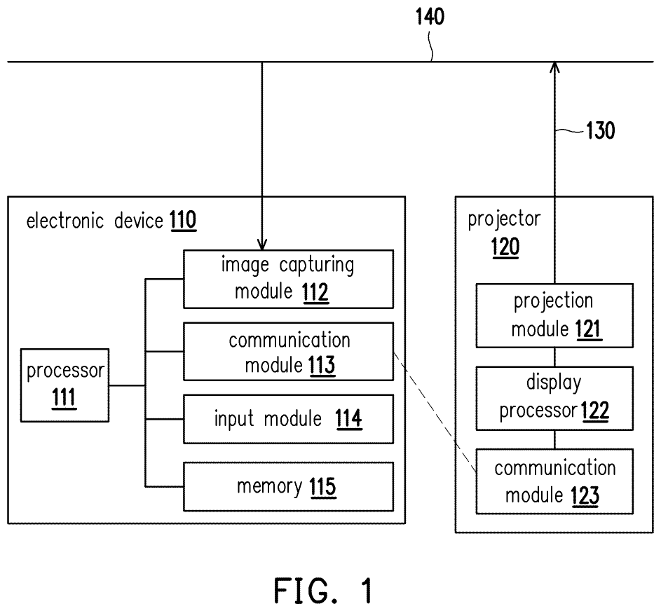

FIG. 1 is a schematic diagram illustrating a color temperature calibration system according to an embodiment. Referring to FIG. 1, the color temperature calibration system includes an electronic device 110 and a projector 120, which are communicatively connected to each other. The electronic device 110 may be a smartphone, laptop computer, tablet computer, personal digital assistant, etc.

The electronic device 110 includes a processor 111, an image capturing module 112, a communication module 113, an input module 114, and a memory 115. The modules may be implemented as circuits or devices. The processor 111 is coupled to the image capturing module 112, the communication module 113, the input module 114, and the memory 115. The processor 111 may be a central processing unit, microprocessor, microcontroller, Application Specific Integrated Circuits (ASIC), Programmable Logic Device (PLD), etc. The image capturing module 112 may include a lens, aperture, shutter, light sensor, etc. The light sensor may be a Charge-coupled Device (CCD) sensor, Complementary Metal-Oxide Semiconductor (CMOS) sensor, or other suitable photosensitive components. The communication module 113 may include circuits supporting near-field communication, infrared communication, Bluetooth, or Wi-Fi communication functions. The input module 114 may include a touch screen, keyboard, or mouse, etc. The memory 115 may include internal memory, flash memory, read-only memory, etc., in which an application program is stored and executed by the processor 111.

The projector 120 includes a projection module 121, a display processor 122, and a communication module 123. The modules may be referred to as circuits or devices. The display processor 122 is coupled to the projection module 121 and the communication module 123. The projection module 121 is configured to project projection images onto a projection surface. The projection module 121 may include a Digital Micromirror Device (DMD), Liquid Crystal Display (LCD) panel, Liquid Crystal on Silicon (LCoS) panel, Digital Light Processing (DLP) unit, light source, zoom lens, zoom motor, or other display-related components. The display processor 122 may be, for example, a microprocessor, display chip, microcontroller, Application Specific Integrated Circuit, Programmable Logic Device, etc. The communication module 123 may include circuits supporting near-field communication, infrared communication, Bluetooth, or Wi-Fi communication functions, used to communicatively connect to the communication module 113 of the electronic device 110.

The projector 120 is configured to project a calibration image light beam 130 onto the projection surface 140 to form a calibration image, while the image capturing module 112 of the electronic device 110 captures an image towards the projection surface 140 through a user operation to obtain an environment image. According to this environment image and other information obtained during image capture, the electronic device 110 may assist the projector 120 in performing color temperature calibration.

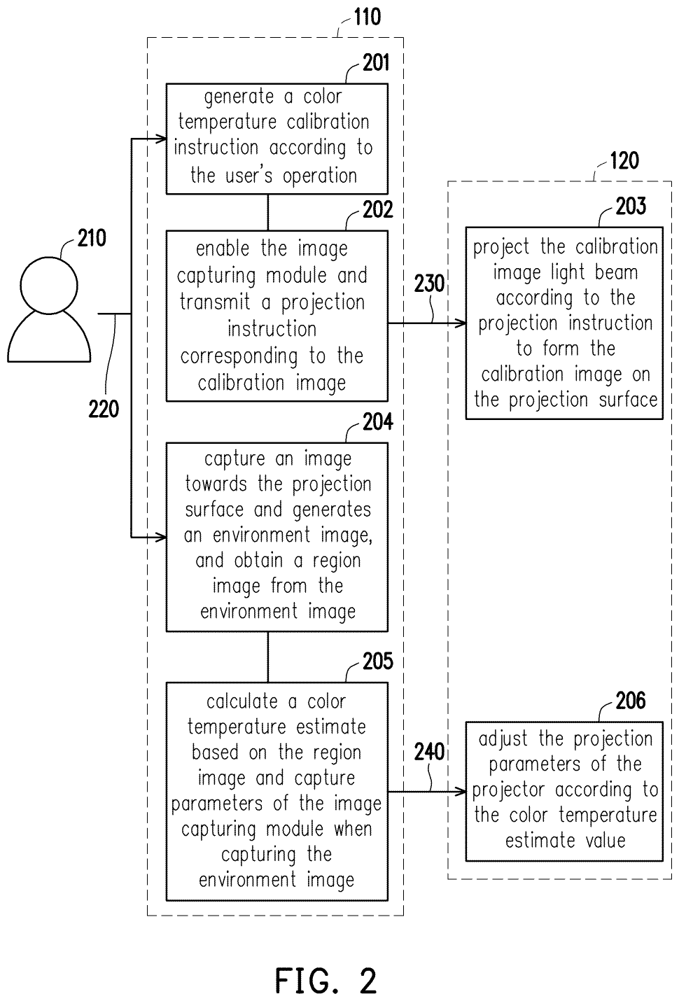

FIG. 2 is a flowchart illustrating the operation of a color temperature calibration system according to an embodiment. Referring to FIG. 1 and FIG. 2, first, the user 210 performs an operation 220 on the electronic device 110, causing the electronic device 110 to perform step 201: generating a color temperature calibration instruction according to the user 210's operation 220. In some embodiments, the processor 111 executes an application program stored in the memory 115. This application program provides an interface that may include one or more graphical objects including buttons, menus, sliders, etc. The user 210 may perform the operation 220 on this interface, for example, by pressing a button corresponding to a function for activating the color temperature calibration. Then, the application program causes the processor 111 to generate a color temperature calibration instruction based on this operation 220. The color temperature calibration instruction enables the electronic device 110 to enter a mode for automatically adjusting the color temperature of the projector 120.

In response to the electronic device 110 generating the color temperature calibration instruction by the processor 111 based on the user 210's operation 220, in step 202, the processor 111 enables the image capturing module 112 and transmits a projection instruction 230 corresponding to the calibration image to the projector 120. The projection instruction 230 is configured to instruct the projector 120 to project a calibration image light beam corresponding to the calibration image. In some embodiments, the processor 111 may select one image from multiple preset images as the calibration image to be presented on the projection surface, and then transmit the projection instruction 230 corresponding to this calibration image to the projector 120. In other embodiments, multiple options corresponding to multiple preset images may be provided on the application program executed by the processor 111, allowing the user 210 to choose the calibration image to be presented on the projection surface. The processor 111 then generates the projection instruction 230 corresponding to the selected calibration image to the projector 120. Since the processor 111 knows which preset image is the calibration image, it may also obtain relevant information about this calibration image, such as the gray level of each color channel and the size of the image.

In step 203, the projector 120 receives the projection instruction 230 and projects the calibration image light beam 130 according to the projection instruction 230 to form the calibration image on the projection surface 140. This calibration image may be a single-color image or an image with various patterns. The disclosure does not limit the content of the calibration image.

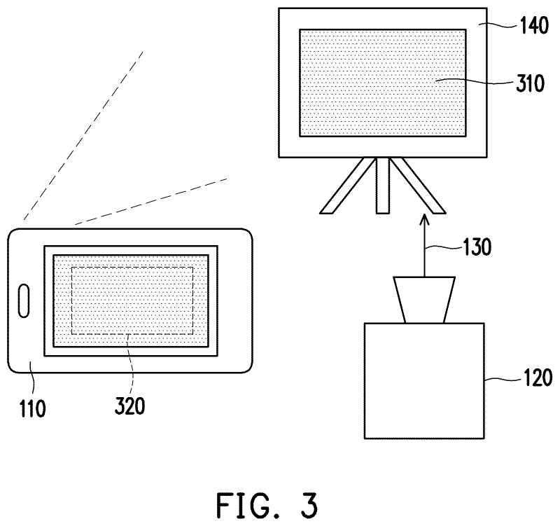

Next, the user 210 performs an operation 220 on the electronic device 110, such as holding the electronic device 110 towards the calibration image to capture it. FIG. 3 is a schematic diagram illustrating the capturing of the calibration image according to an embodiment. Referring to FIG. 2 and FIG. 3, the projector 120 projects the calibration image light beam 130 to form a calibration image 310 on the projection surface 140. In some embodiments, the application program executed on the electronic device 110 may prompt the user 210 to take a photo, and mark a range 320 in the preview screen of the electronic device 110, prompting the user 210 to adjust the angle, position, or focus of the electronic device 110 so that the calibration image 310 in the preview screen falls within this range 320. Preferably, the calibration image 310 in the preview screen should completely cover the entire range 320. In some embodiments, the electronic device 110 may also set a threshold value for the percentage of the range 320 covered by the calibration image 310 in the preview screen, such as 75%, 85%, or 95%. If the percentage of the range 320 covered by the calibration image 310 in the preview screen does not reach the threshold value, it continues to remind the user 210 to make adjustments. The photo may only be taken when the percentage of the range 320 covered by the calibration image 310 in the preview screen exceeds the threshold value.

In response to the user 210's operation 220 of capturing the calibration image 310 with the electronic device 110, in step 204, the image capturing module 112 captures an image towards the projection surface 140 and generates an environment image. Furthermore, the processor 111 obtains a region image from the environment image. For example, the processor 111 may extract pixels within the range 320 as the region image. In some embodiments, if the calibration image 310 contains specific patterns or markers, such as QR codes placed around the calibration image 310, the processor 111 may also recognize the patterns or markers in the environment image, and then obtain the region image from the corresponding position. Through this approach, the region image will correspond to at least a portion of the calibration image 310. It is to measure the environmental color temperature in this embodiment, since the image captured by the image capturing module 112 is formed by the calibration image plus environmental factors, and the information of the calibration image can be known in advance, therefore, by extracting the calibration image (region image), the color temperature information about the environment can be calculated.

In step 205, the processor 111 calculates a color temperature estimate based on the region image and multiple capture parameters of the image capturing module 112 when capturing the environment image. The capture parameters refer to the parameters related to the lens, image sensor, or algorithms of the image capturing module 112, rather than the parameters of the environment image. The multiple capture parameters are determined by the image capturing module 112 according to the environment when capturing the image. For example, the capture parameters may include shutter speed, aperture size, sensitivity, white balance parameters, and exposure compensation parameters. Shutter speed (i.e., exposure time) refers to the duration of time that the shutter of the image capturing module 112 is open, during which light passes through the lens of the image capturing module 112 and projects onto the image sensor. The length of exposure time directly affects the amount of light, thereby influencing the brightness, color saturation, and dynamic capture effects of the image. The aperture size determines the amount of light entering the image capturing module 112; the larger the aperture (smaller f-number), the more light enters, resulting in a more pronounced background blur (shallow depth of field); the smaller the aperture (larger f-number), the less light enters, resulting in a deeper depth of field. Moreover, higher sensitivity may increase image noise, potentially affecting color purity. White balance parameters refer to the relevant parameters used by the processor 111 when executing a white balance algorithm. The main function of the white balance algorithm is to adjust the colors in the image to make them appear more natural or closer to what the human eye sees, and different white balance parameters can produce different colors. Exposure compensation parameters are used to adjust the brightness of the image, for example, they may include but are not limited to Exposure Value (EV). In other embodiments, the capture parameters may also include parameters related to high dynamic range algorithms, contrast enhancement algorithms, noise reduction algorithms, gamma correction algorithms, etc., all of which affect the gray levels of pixels.

The image capturing module 112 has its own mechanism to determine capture parameters such as shutter speed, aperture size, and sensitivity. For example, when the ambient brightness is low, it may decrease the shutter speed, increase the aperture size (decrease the f-number), and increase the sensitivity. These capture parameters reflect the environmental conditions. Generally, the image capturing module 112 is affected by the environment during image capture, and the resulting environment image may vary due to environmental factors. At the same time, the environment image may also differ due to the adjustment mechanisms of the image capturing module 112 itself. For instance, image capturing modules 112 on different electronic devices 110 may have different specifications, and the image capturing module 112 may apply different image correction or color adjustment algorithms to process pixels. If only the pixels in the image are used for color temperature analysis, it may not accurately represent the actual color temperature of the environment. In this embodiment, calculating the environmental color temperature (i.e., the color temperature estimate) based on the region image from the environment image and the capture parameters yields a more accurate representation of the actual environmental color temperature.

In some embodiments, the processor 111 of the electronic device 110 transmits the aforementioned capture parameters and region image to a machine learning model to obtain multiple first primary color values from the machine learning model. This machine learning model may be, for example, a large language model, decision tree, random forest, k-nearest neighbor algorithm, multi-layer neural network, convolutional neural network, support vector machine, XGBoost, Autoencoder, etc., but the disclosure is not limited to these. The architecture of the convolutional neural network may adopt LeNet, AlexNet, VGG, GoogLeNet, ResNet, DenseNet or YOLO (You Only Look Once). When training the machine learning model, the labels for the training data may be generated through measurements with a colorimeter. The aforementioned machine learning model may be stored in the electronic device 110 (such as in the memory 115), or it may also be set up on a cloud server, but the disclosure is not limited to this. In some embodiments, the aforementioned multiple first primary color values correspond to different color channels, for example, red, green, and blue color channels. The processor 111 calculates three primary color values corresponding to the color temperature through the machine learning model based on the captured region image and capture parameters.

On the other hand, the processor 111 also calculates multiple second primary color values based on the region image. For example, the processor 111 may average the grayscale values of all pixels in the region image to calculate the second primary color values. In some embodiments, the processor 111 may also execute any image processing algorithm to calculate the second primary color values based on principles such as the Gray World Assumption or the Perfect Reflector Assumption. In some embodiments, these second primary color values also correspond to different color channels, for example, red, green, and blue color channels.

Next, a color temperature estimate is calculated based on the aforementioned multiple first primary color values and multiple second primary color values. For example, for each color channel, the processor 111 may perform a weighted sum of the corresponding first primary color value and the corresponding second primary color value to obtain a corresponding color estimate value. In other words, three color channels will generate three color estimate values, as shown in the following Mathematical Formula 1.

$${R}_{e} = {w}_{1} \times {R}_{Im} + {w}_{2} \times {R}_{AI} \qquad [ Mathematical Formula 1 ]$$

$${G}_{e} = {w}_{1} \times {G}_{Im} + {w}_{2} \times {G}_{AI}$$

$${B}_{e} = ( {w}_{1} \times {B}_{Im} + {w}_{2} \times {B}_{AI} ) \times α$$

Rₑ is the color estimate value corresponding to the red channel, Gₑ is the color estimate value corresponding to the green channel, Bₑ is the color estimate value corresponding to the blue channel. R_{Im} is the second primary color value corresponding to the red channel, G_{Im} is the second primary color value corresponding to the green channel, B_{Im} is the second primary color value corresponding to the blue channel. R_{AI} is the first primary color value corresponding to the red channel, G_{AI} is the first primary color value corresponding to the green channel, B_{AI} is the first primary color value corresponding to the blue channel. w₁ and w₂ are weights, where w₁+w₂=1, for example, w₁=0.4, w₂=0.6. α is an adjustment parameter, for example, 0.92. In some embodiments, α may also be 1, which is not limited in the disclosure.

In the above embodiment, the calculation results from the machine learning model are combined with the calculation results from image processing based on the region image to calculate multiple color estimate values. However, in other embodiments, information from the calibration image itself may also be added. Specifically, the processor 111 stores multiple third primary color values corresponding to the image data of the calibration image (or multiple three primary color values corresponding to the light beam of the calibration image). For example, the calibration image is a single-color image, where all pixels in the pure color image have the same gray levels, and these gray levels can be used as the third primary color values. In some embodiments, these third primary color values also correspond to different color channels, for example, red, green, and blue color channels. For each color channel, the processor 111 performs a weighted sum of the corresponding first primary color value, the corresponding second primary color value, and the corresponding third primary color value to obtain the corresponding color estimate value. This calculation can be represented by the following Mathematical Formula 2.

$${R}_{e} = {w}_{1} \times {R}_{Im} + {w}_{2} \times {R}_{AI} + {w}_{3} \times {R}_{c} \qquad [ Mathematical Formula 2 ]$$

$${G}_{e} = {w}_{1} \times {G}_{Im} + {w}_{2} \times {G}_{AI} + {w}_{3} \times {G}_{c}$$

$${B}_{e} = ( {w}_{1} \times {B}_{Im} + {w}_{2} \times {B}_{AI} + {w}_{3} \times {B}_{c} ) \times α$$

R_{c} is the third primary color value corresponding to the red channel, G_{c} is the third primary color value corresponding to the green channel, B_{c} is the third primary color value corresponding to the blue channel. w₃ is a weight, in this example w₁+w₂+w₃=1, for example, w₁=0.35, w₂=0.5, w₃=0.15. Additionally, α=0.92 in this example. The reason for designing the adjustment parameter a is that in some cases, the lens of the image capturing module 112 is more sensitive to blue, and multiplying the primary color value of the blue channel by the adjustment parameter a can result in a more accurate color temperature. In some embodiments, a may also be 1, which is not limited in the disclosure.

Whether using the above Mathematical Formula 1 or Mathematical Formula 2, the processor 111 calculates a color temperature estimate value based on the color estimate values. Generally, a higher color temperature tends towards red, while a lower color temperature tends towards blue. Based on the three color estimate values mentioned above, the approximate color can be evaluated, and thus the color temperature estimate value can be calculated. In some embodiments, the processor 111 calculates the ratio between the color estimate value corresponding to the blue channel and the sum of all color estimate values, represented by the following Mathematical Formula 3.

$$\frac{{B}_{e}}{{R}_{e} + {G}_{e} + {B}_{e}} \qquad [ Mathematical Formula 3 ]$$

Next, the color temperature estimate value can be obtained based on the ratio calculated from Mathematical Formula 3. For example, when the ratio calculated from Mathematical Formula 3 is higher, the color temperature estimate value is lower; when the ratio is lower, the color temperature estimate value is higher. In some embodiments, the unit of the color temperature estimate value is ° K, but in other embodiments, the color temperature estimate value may also be a value on any scale used to represent the level of color temperature. The processor 111 may input the above ratio into any function to calculate the color temperature estimate value. This function may include linear functions, polynomial functions, exponential functions, etc., but the disclosure is not limited to these.

In some embodiments, the color temperature estimate value may be obtained from the ratio calculated according to Mathematical Formula 3 and a lookup table. For example, the lookup table can be established in advance. In experimental data, the true color temperature estimate value can be obtained through a colorimeter, and then these true color temperature estimate values and corresponding ratios can be written into the lookup table. The processor 111 may input the ratio calculated from Mathematical Formula 3 into the lookup table to obtain the color temperature estimate value. Since the lookup table only contains a limited number of ratios, if the calculated ratio is not exactly the same as the ratios in the lookup table, inputting the ratio into the lookup table will result in two closest color temperature estimate values. These two color temperature estimate values form an approximate color temperature range, and then the color temperature estimate value can be calculated by a linear interpolation based on this approximate color temperature range. For example, if the currently calculated ratio is Rt, and the values closest to ratio Rt in the lookup table are ratio R1 and ratio R2, where R1<R2. The ratio R1 corresponds to a color temperature estimate value K1 in the lookup table, and the ratio R2 corresponds to a color temperature estimate value K2 in the lookup table. Therefore, the processor 111 can obtain the approximate color temperature range K1-K2 based on the ratio R1 and ratio R2, and calculate the color temperature estimate value Kt by the linear interpolation. The detailed calculation is expressed as the following Mathematical Formula 4.

$${K}_{t} = K 1 + \frac{K 2 - K 1}{R 2 - R 1} \times ( {R}_{t} - R 1 ) \qquad [ Mathematical Formula 4 ]$$

Please refer to FIG. 2. Next, the processor 111 of the electronic device 110 transmits the calculated color temperature estimate value 240 to the projector 120 through the communication module 113. In step 206, the projector 120 adjusts the projection parameters of the projector 120 according to the color temperature estimate value 240. These projection parameters may include color temperature, the gain of a certain color channel, etc., but the disclosure is not limited to these. Since the color temperature estimate value 240 represents the color temperature of the calibration image, in some embodiments, the display processor 122 in the projector 120 may further compare the color temperature estimate value 240 with the color of the calibration image to determine how to adjust the projection parameters.

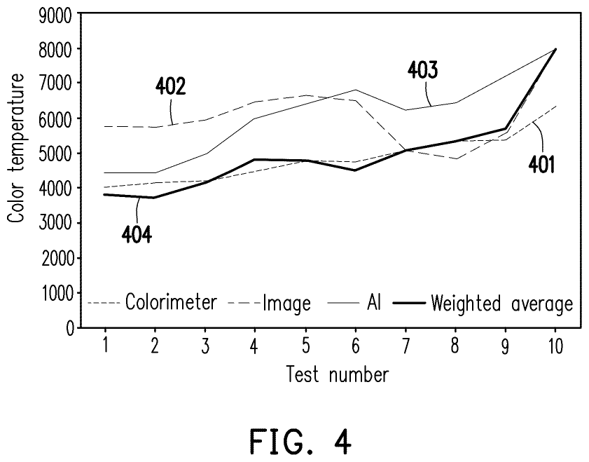

FIG. 4 is a schematic diagram showing experimental results according to an embodiment. Please refer to FIG. 4, where the horizontal axis represents test numbers, with different test numbers representing different calibration images or different environments, and the vertical axis represents the color temperature (or color temperature estimate value). FIG. 4 shows curves 401-404, where the curve 401 represents the true color temperature measured by a colorimeter; the curve 402 represents the color temperature estimate value calculated solely based on the region image; the curve 403 represents the color temperature estimate value calculated using only the machine learning algorithm; the curve 404 represents the color temperature estimate value calculated using the aforementioned Mathematical Formula 2 and corresponding weighted average. From FIG. 4, it can be seen that the trend of the curve 404 is close to that of the curve 401, which means that combining multiple pieces of information with weighted average can calculate a color temperature that is more consistent with the actual situation.

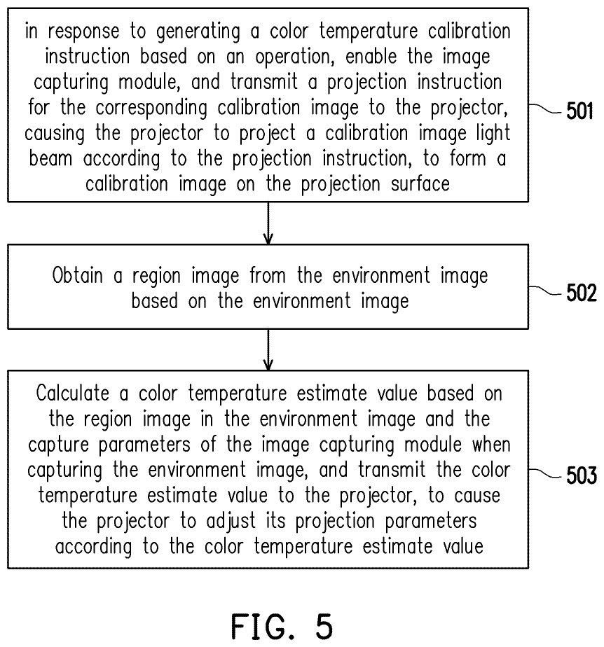

FIG. 5 is a flowchart of a color temperature calibration method according to an embodiment. Please refer to FIG. 5. In step 501, in response to generating a color temperature calibration instruction based on an operation, the image capturing module is enabled, and a projection instruction for the corresponding calibration image is transmitted to the projector, causing the projector to project a calibration image light beam according to the projection instruction, to form a calibration image on the projection surface. In step 502, a region image is obtained from the environment image based on the environment image, where the environment image is generated by the image capturing module capturing towards the projection surface, and the region image corresponds to at least a portion of the calibration image. In step 503, a color temperature estimate value is calculated based on the region image in the environment image and the capture parameters of the image capturing module when capturing the environment image, and the color temperature estimate value is transmitted to the projector, to cause the projector to adjust its projection parameters according to the color temperature estimate value. The steps in FIG. 5 have been explained in detail as above, so the description will not be repeated here. It is worth noting that each step in FIG. 5 may be implemented as codes or circuits, and the disclosure is not limited to this. Moreover, the method of FIG. 5 can be used in conjunction with the above embodiments or used independently. In other words, other steps may also be added between the steps of FIG. 5.

The disclosure also proposes a non-transitory computer-readable storage media including random access memory, read-only memory, flash memory, floppy disk, hard disk, optical disc, USB flash drive, magnetic tape, etc. This non-transitory computer-readable storage media stores an application program that is executed by a processor. When this application program is executed by the processor, it is configured to perform the aforementioned color temperature calibration method.

In summary, the color temperature calibration system and method of the disclosure embodiments have at least one of the following advantages. Firstly, using an electronic device to assist in color temperature calibration may solve the problem of projectors lacking sensors. Secondly, the above embodiments additionally adopt capture parameters rather than just using image pixels to calculate color temperature, avoiding the influence of various algorithms on the electronic device. Thirdly, using weighted average to calculate the color temperature estimate value can integrate the advantages of various methods, obtaining data closer to reality. Through the above means, user experience can be enhanced, image quality performance can be improved, and the time for color temperature calibration can be reduced by utilizing electronic devices.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A color temperature calibration system, comprising a projector and an electronic device communicatively connected to each other, wherein:
the electronic device comprises a processor and an image capturing module communicatively connected,
in response to the electronic device generating a color temperature calibration instruction according to an operation, the processor is configured to enable the image capturing module, and transmit a projection instruction corresponding to a calibration image to the projector, the projector projects a calibration image light beam according to the projection instruction, to form the calibration image on a projection surface,
the image capturing module is configured to capture an image towards the projection surface and generate an environment image,
the processor is configured to obtain a region image from the environment image according to the environment image, wherein the region image corresponds to at least a portion of the calibration image,
according to the region image in the environment image and a plurality of capture parameters of the image capturing module when capturing the environment image, the processor is configured to calculate a color temperature estimate value, and transmits the color temperature estimate value to the projector,
the projector is configured to adjust at least one projection parameter of the projector according to the color temperature estimate value.

2. The color temperature calibration system of claim 1, wherein the capture parameters comprise at least one of shutter speed, aperture size, sensitivity, white balance parameters, and exposure compensation parameters.

3. The color temperature calibration system of claim 2, wherein the processor is configured to transmit the capture parameters and the region image in the environment image to a machine learning model, to obtain a plurality of first primary color values from the machine learning model,
the processor is configured to calculate a plurality of second primary color values according to the region image in the environment image, and calculates the color temperature estimate value according to the first primary color values and the second primary color values.

4. The color temperature calibration system of claim 3, wherein the first primary color values correspond to different ones of a plurality of color channels respectively, the second primary color values correspond to different ones of the color channels respectively,
wherein for each of the color channels, the processor is configured to perform a weighted sum on the corresponding first primary color value and the corresponding second primary color value, to obtain a corresponding color estimate value,
wherein the processor is configured to calculate the color temperature estimate value according to the color estimate values.

5. The color temperature calibration system of claim 4, wherein the color channels comprise a red channel, a green channel and a blue channel, the processor is configured to calculate a ratio between the color estimate value corresponding to the blue channel and a sum of the color estimate values, and obtain the color temperature estimate value according to the ratio.

6. The color temperature calibration system of claim 3, wherein the processor stores a plurality of third primary color values corresponding to an image data of the calibration image, the first primary color values correspond to different ones of a plurality of color channels respectively, the second primary color values correspond to different ones of the color channels respectively, the third primary color values correspond to different ones of the color channels respectively,
wherein for each of the color channels, the processor is configured to perform a weighted sum on the corresponding first primary color value, the corresponding second primary color value, and the corresponding third primary color value, to obtain a corresponding color estimate value,
wherein the processor calculates the color temperature estimate value according to the color estimate values.

7. The color temperature calibration system of claim 6, wherein the color channels comprise a red channel, a green channel and a blue channel, the processor is configured to calculate a ratio between the color estimate value corresponding to the blue channel and a sum of the color estimate values, and obtain the color temperature estimate value according to the ratio.

8. The color temperature calibration system of claim 7, wherein the processor is configured to obtain the color temperature estimate value according to the ratio and a lookup table.

9. The color temperature calibration system of claim 8, wherein the processor is configured to obtain an approximate color temperature range according to the ratio and the lookup table, and calculate the color temperature estimate value by a linear interpolation based on the approximate color temperature range.

10. The color temperature calibration system of claim 1, wherein the electronic device comprises an application program, wherein when the processor executes the application program, the application program causes the processor to generate the color temperature calibration instruction according to the operation.

11. A color temperature calibration method, comprising:
responding to a color temperature calibration instruction generated according to an operation, enabling an image capturing module, and transmitting a projection instruction corresponding to a calibration image to a projector, to cause the projector to project a calibration image light beam according to the projection instruction, so as to form the calibration image on a projection surface;
obtaining a region image in an environment image according to the environment image, wherein the environment image is generated by the image capturing module capturing towards the projection surface, and the region image corresponds to at least a portion of the calibration image; and
calculating a color temperature estimate value according to the region image in the environment image and a plurality of capture parameters of the image capturing module when capturing the environment image, and transmitting the color temperature estimate value to the projector, to cause the projector to adjust at least one projection parameter of the projector according to the color temperature estimate value.

12. The color temperature calibration method of claim 11, wherein the capture parameters comprise at least one of shutter speed, aperture size, sensitivity, white balance parameter and exposure compensation parameter.

13. The color temperature calibration method of claim 12, further comprising:
transmitting the capture parameters and the region image in the environment image to a machine learning model, to obtain a plurality of first primary color values from the machine learning model; and
calculating a plurality of second primary color values according to the region image in the environment image, and calculating the color temperature estimate value according to the first primary color values and the second primary color values.

14. The color temperature calibration method of claim 13, wherein the first primary color values correspond to different ones of a plurality of color channels respectively, the second primary color values correspond to different ones of the color channels respectively, the color temperature calibration method further comprising:
for each of the color channels, performing a weighted sum on the corresponding first primary color value and the corresponding second primary color value, to obtain a corresponding color estimate value; and
calculating the color temperature estimate value according to the color estimate values.

15. The color temperature calibration method of claim 14, wherein the color channels comprise a red channel, a green channel and a blue channel, and the color temperature calibration method further comprises:
calculating a ratio between the color estimate value corresponding to the blue channel and a sum of the color estimate values, and obtaining the color temperature estimate value according to the ratio.

16. The color temperature calibration method of claim 13, further comprising:
accessing a plurality of third primary color values corresponding to an image data of the calibration image, wherein the first primary color values correspond to different ones of a plurality of color channels respectively, the second primary color values correspond to different ones of the color channels respectively, the third primary color values correspond to different ones of the color channels respectively;
for each of the color channels, performing a weighted sum on the corresponding first primary color value, the corresponding second primary color value, and the corresponding third primary color value, to obtain a corresponding color estimate value; and
calculating the color temperature estimate value according to the color estimate values.

17. The color temperature calibration method of claim 16, wherein the color channels comprise a red channel, a green channel and a blue channel, the color temperature calibration method further comprising:
calculating a ratio between the color estimate value corresponding to the blue channel and a sum of the color estimate values, and obtaining the color temperature estimate value according to the ratio.

18. The color temperature calibration method of claim 17, further comprising:
obtaining the color temperature estimate value according to the ratio and a lookup table.

19. The color temperature calibration method of claim 18, further comprising:
obtaining an approximate color temperature range according to the ratio and the lookup table, and calculating the color temperature estimate value by a linear interpolation based on the approximate color temperature range.

20. A non-transitory computer-readable storage medium, storing an application program executable by a processor, wherein when the application program is executed by the processor, it is configured to perform the color temperature calibration method of claim 11.
